(19) United States
(12) Patent Application Publication
(10) Pub. No.: US 2024/0010462 A1
(43) Pub. Date: Jan. 11, 2024

(54) ELEVATOR DEVICE

(71) Applicant: Hitachi, Ltd., Tokyo (JP)

(72) Inventors: Yuya NAKAMORI, Tokyo (JP); Yohei MATSUMOTO, Tokyo (JP); Hajime KANZAKI, Tokyo (JP)

(21) Appl. No.: 18/269,972

(22) PCT Filed: Jan. 14, 2021
(86) PCT No.: PCT/JP2021/000972

§ 371 Date: Jun. 28, 2023

(51) Int. Cl. B66B 1/34

(52) U.S. Cl. CPC B66B 1/3461

(57) ABSTRACT

An elevator device has multiple antennas installed to an elevator car to generate a synthetic radio wave, where each antenna is arrangeable to suppress the influence of fading while securing a work space for workers The elevator device mediates wireless communications for communications between a control board of a hoistway and a control device of the elevator car and includes: a guide rail installed to the hoistway; the elevator car that moves up and down while being guided by the guide rail; a wireless transmitter provided to the top portion of the hoistway; multiple wireless receivers provided to the upper portion of the elevator car; a guide roller that grips the guide rail; and a support mechanism that rotatably supports the guide roller. At least one of the multiple wireless receivers is installed to the upper portion of the support mechanism provided to the top surface of the elevator car.

### TECHNICAL FIELD

The present invention relates to an elevator device that mediates wireless communications for communications between a control board in a hoistway and a control device on a side of an elevator car.

### BACKGROUND ART

Some elevator devices installed to skyscrapers use wireless communications established between a wireless communication device on a side of a hoistway and a wireless communication device on a side of an elevator car for communications between the control board in the hoistway and the control device on the side of the elevator car instead of wired communications using a tale code.

For example, the abstract of Patent Literature 1 describes a wireless communication device for elevators. This wireless communication device “widens a range of a communication distance in an elevator to prevent interference of wireless communication signals that may occur when communications are made using both a short distance communication antenna and a long distance communication antenna and switches these antennas automatically to prevent data corruption of wireless signals that may occur on the antenna switching.” This wireless communication device “provides multiple types of antennas including short distance communication antennas 9 and 12 and long distance communication antennas 8 and 13 to a device of an elevator machine room 1 and an elevator car 5, respectively.” This wireless communication device “further includes antenna switching means 16 that switches between the antennas 8 and 13 in a long distance area and the antennas 9 and 12 in a short distance area to execute wireless communications and indicator identification means 17 that indicates switching of the antenna switching means based on any of indicator signals indicating positions of the elevator contained in the elevator control signals outputted from an elevator control board to a device of the elevator car.”

Moreover, when radio waves transmitted from the antenna on the side of the control board are reflected, scattered, etc. in a hoistway, many radio waves passing through various ways interfere each other and intensities of the radio waves greatly change with location. This is a phenomenon called fading. For this reason, when a position (height in the hoistway) of the antenna on the side of an elevator car during raising or lowering of the elevator car changes, the intensity of a received radio wave greatly changes under the influence of fading. For this reason, there is also an elevator device that uses diversity processing for maintenance of communication quality. In the diversity processing, multiple antennas are installed to an elevator car to receive high quality signals even in a fading environment. The best received radio waves are then selected from received radio waves of each antenna at each time to generate a synthetic radio wave and to minimize level fluctuation of the synthetic radio wave.

### CITATION LIST

### Patent Literature

Patent Literature 1: JP 2003-300677 A

### SUMMARY OF INVENTION

### Technical Problem

It is necessary to install multiple antennas on an elevator car for realization of the above diversity processing. However, various devices are mounted on the elevator car. Further, since a work space for maintenance personnel is also required, the place where an antenna can be disposed is restricted.

Patent Literature 1 discloses an elevator car side wireless communication device having two antennas. Each antenna is used exclusively for short distance communications or for long distance communications. It is not assumed that the antennas are simultaneously used to generate a synthetic radio wave and to thus improve degradation in reliability of radio wave propagation due to fading.

For this reason, it is an object of the present invention to provide an elevator device in which, when multiple antennas are installed to an elevator car to generate a synthetic radio wave, each antenna can be disposed to suppress the influence of fading while a work space for a maintenance personnel is ensured.

### Solution to Problem

For solving the above problem, an elevator device of the present invention mediates wireless communications for communications between a control board of a hoistway and a control device of an elevator car. The elevator device includes: a guide rail installed to the hoistway; an elevator car that moves up and down while being guided by the guide rail; a wireless transmitter provided to a top portion of the hoistway; multiple wireless receivers provided to an upper portion of the elevator car; a guide roller that grips the guide rail; and a support mechanism that rotatably supports the guide roller. At least one of the multiple wireless receivers is installed to an upper portion of the support mechanism provided to an upper surface of the elevator car.

### Advantageous Effects of Invention

According to the elevator device of the present invention, when multiple antennas are installed to the elevator car to generate a synthetic radio wave, each antenna can be disposed to prevent the influence of fading while a work space for a maintenance personnel is ensured.

### BRIEF DESCRIPTION OF DRAWINGS

FIG. 1 is a perspective diagram showing an upper structure of an elevator car of the present invention.

FIG. 2 is a schematic diagram of an entire elevator device of the present invention.

FIG. 3 is a perspective diagram showing an adjustment mechanism of a wireless communication device of Embodiment 1.

FIG. 4 is a flow chart that shows a determination procedure of an antenna position of a wireless receiver.

FIG. 5 is a perspective diagram showing an adjustment mechanism of a wireless communication device of Embodiment 2.

### DESCRIPTION OF EMBODIMENTS

Hereinafter, Embodiments of an elevator of the present invention are described using drawings.

### Embodiment 1

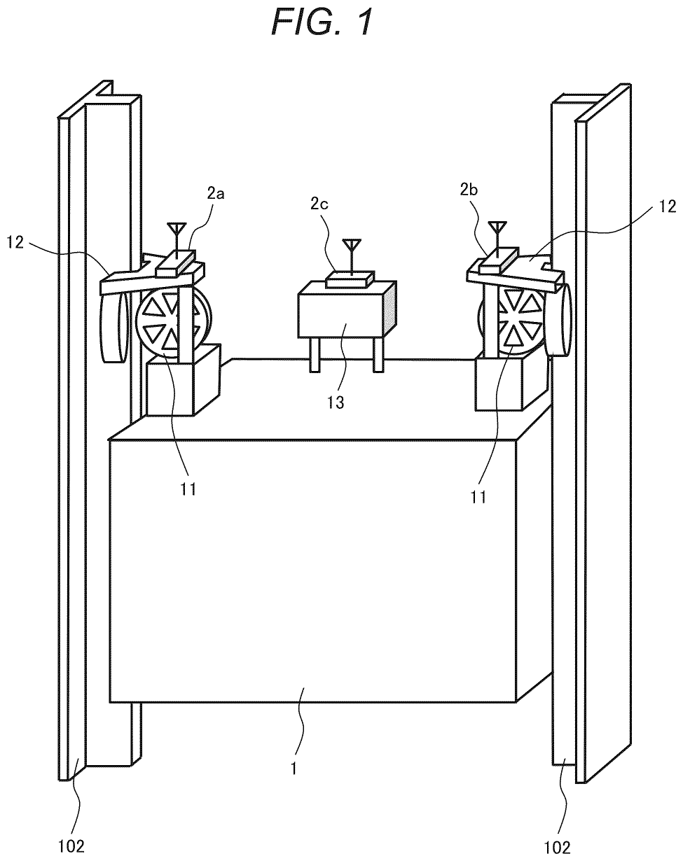

First, an elevator device 100 of Embodiment 1 of the present invention is explained using FIGS. 1 to 4.

### <Elevator Device 100>

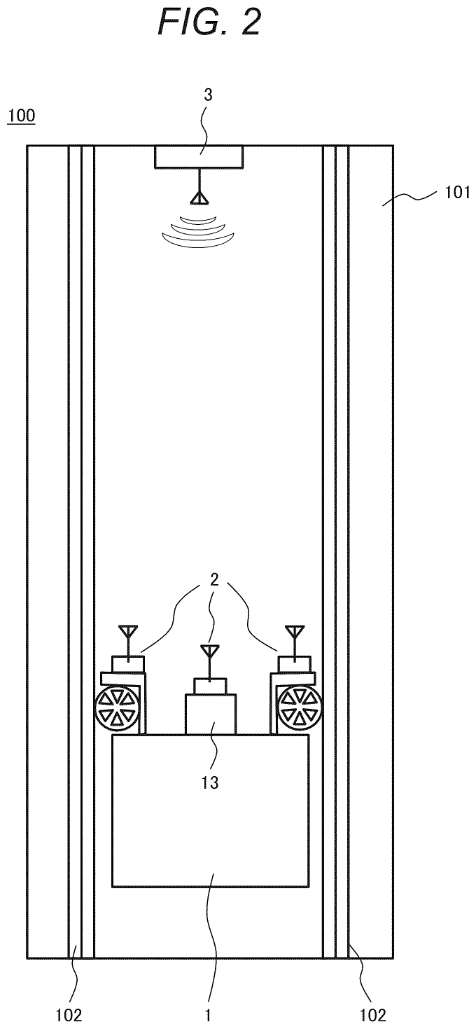

FIG. 2 is a schematic diagram of the entire elevator device 100 of the present Embodiment. The elevator device 100 shown here communicates management information (floor information etc.) and control information (light activation, light deactivation, etc.) interactively between a control board (not shown) in a hoistway and a control device 13 of an elevator car 1. The elevator device 100 includes: multiple guide rails 102 installed vertically in the hoistway 101; the elevator car 1 that moves up and down while being guided by the guide rails 102; multiple wireless communication devices (hereinafter called “wireless receivers 2” by focusing on the receiving function) installed to the upper portion of the elevator car 1; and a wireless communication device (hereinafter called a “wireless transmitter 3” by focusing on the transmitting function) installed to the top portion of the hoistway 101. It is noted that each wireless receiver 2 is wired to the control device 13 of the elevator car 1 and the wireless transmitter 3 is wired to the control board in the hoistway. Moreover, the elevator device 100 includes a main rope to suspend the elevator car 1, a hoist that hoists the main rope, a counter weight, etc. These known components are not illustrated in FIG. 2.

FIG. 1 is a perspective diagram showing details of an upper structure of the elevator car 1. As shown here, for suppression of vibration during up-and-down movement, the upper portion of the elevator car 1 has a guide roller 11 that grips each guide rail 102 from three sides and a support mechanism 12 that supports the guide roller 11 rotatably. Further, a control device 13 that controls, e.g., opening and closing of a door of the elevator car 1 is disposed to the upper portion of the elevator car 1.

Here, to establish preferable communications from the control board in the hoistway to the control device of the elevator car 1 in a fading environment regardless of the height of the elevator car 1 as in FIG. 2, it is necessary to install the multiple wireless receivers 2 to the upper portion of the elevator car 1 oppositely to the above wireless transmitter 3, to generate a less level fluctuated synthetic radio wave from received radio waves of the respective wireless receivers 2 by use of diversity processing with the control device of the elevator car 1, and to detect management information and control information based on the synthetic radio wave. However, unillustrated various devices other than the support mechanism 12 and control device 13 are installed to the upper surface of the elevator car 1. Additionally, a work space for maintenance by maintenance personnel is necessary. It is thus uneasy to ensure the installation places for the multiple wireless receivers 2.

Additionally, when the antennas of the wireless receivers 2 are installed near other devices, transmitted radio waves of the wireless transmitter 3 are reflected, and scattered, etc. resulting in a decrease in intensity of the radio waves receivable by the wireless receivers 2. This is local fading, requiring attention. In general, correlation of radio waves is low at a position distant by a wavelength λ/2 or more of a transmitted radio wave. Influence of local fading is removed by making the wireless receivers 2 away from other devices by λ/2 or more. For example, the wavelength λ of 2.4 GHz radio waves is about 12.5 cm. The wavelength λ of 5 GHz radio waves is about 5 cm. For canceling local fading, a space of 7 cm or more may be ensured around the antenna when 2.4 GHz radio waves are used, and a space of 3 cm or more may be ensured around the antenna when 5 GHz radio waves are used.

Therefore, in the present Embodiment, as shown in FIG. 1, a first wireless receiver 2a out of the multiple wireless receivers 2 is installed to the upper portion of the left support mechanism 12, a second radio wireless 2b is installed to the upper portion of the right support mechanism 12, and a third wireless receiver 2c is installed to the upper portion of the control device 13. By use of such distribution, the multiple wireless receivers 2 are made installable to the upper portion of the elevator car 1 without reducing a work space on the elevator car 1 and with preventing other devices from existing near each wireless receiver 2.

### <Wireless Communication Device 2>

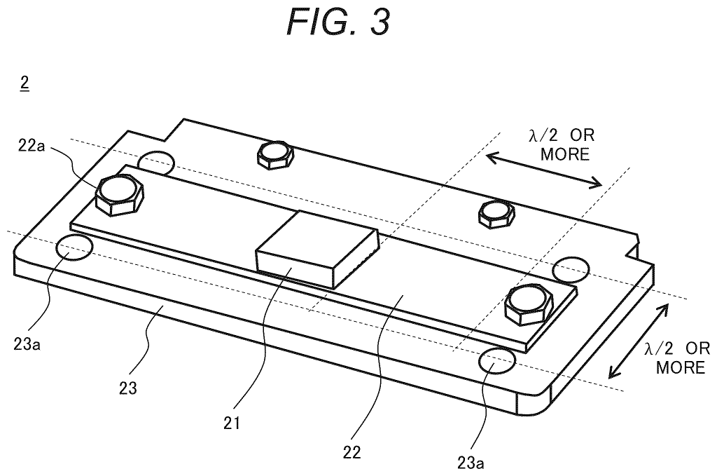

Here, details of the wireless receivers 2 of the present Embodiment are explained using FIG. 3. As described above, when each wireless receiver 2 is distributed to the support mechanisms 12 and the control device 13, the influence of reflection, confusion, etc. of radio waves by peripheral devices is avoidable. The whole hoistway 101 is in fading environment and the radio wave intensity is greatly different by location. Accordingly, the antennas of the wireless receivers 2 may pass through an area where the radio wave intensity is very weak when the elevator car 1 moves up and down. When all the antennas pass through the area where the radio wave intensity is very weak simultaneously, it is difficult to ensure a sufficient radio wave intensity even by use of the synthetic radio wave after subjected to diversity processing. Thus, each antenna needs to be installed to avoid all the antennas from simultaneously passing through the area where the radio wave intensity is weak while the elevator car 1 moves up and down.

However, the radio wave intensity distribution in the hoistway 101 differs in each hoistway and is difficult to grasp in advance. Thus, an installer of the elevator device 100 moves up and down the elevator car 1 in a real environment and finely adjusts each antenna position with evaluating a radio wave intensity of a synthetic radio wave. Then, when a synthetic radio wave having a sufficient radio wave intensity can be constantly acquired regardless of the height of the elevator car 1, the installer needs to determine the combination of the antenna positions at a current time as final antenna positions.

Then, to finely adjust the antenna position even after the wireless receiver 2 is installed to, e.g., the support mechanism 12, the wireless receiver 2 of FIG. 3 includes: an antenna 21 that receives transmitted radio waves of the wireless transmitter 3; a bracket 22 whose general center mounts the antenna 21; a base 23 that regulates a longitudinal position of the bracket 22 and simultaneously secures the wireless receiver 2 to, e.g., the support mechanism 12; and a radio wave processing portion (not shown) that transmits a received radio wave of the antenna 21 to the control device 13 after the received radio wave is filtered etc.

In the wireless receiver 2 of FIG. 3, multiple holes 23a longitudinally arranged linearly at generally same intervals are provided to each transverse edge portion of the base 23. Additionally, a bolt 22a is provided to each transverse edge portion of the bracket 22 to secure the bracket 22 to any one of the holes 23a of the base 23. Here, since three holes 23a are provided to each of the right and left of the base 23, the longitudinal position of the bracket 22, i.e., the longitudinal position of the antenna 21 on the bracket 22 is finely adjusted in three steps. It is noted that the number of the holes 23a is not limited to the illustrated one. For example, two holes 23a may be provided to each the left and right to finely adjust the longitudinal position of the antenna 21 by two steps, or four holes 23a may be provided to each the left and right to finely adjust the longitudinal position of the antenna 21 by four steps. It is noted that, as described above, the correlation of radio waves is low at a distance of λ/2 or more. To change the longitudinal position of the antenna 21 by at least λ/2 or more, a distance between the hole 23a on the most front side and the hole 23a on the most back side is preferably λ/2 or more. Moreover, the distance between the antenna 21 and the bolt 22a also is preferably ensured by λ/2 or more to avoid the influence of, e.g., radio wave reflection by the bolt 22a.

The position of the antenna 21 is adjusted in one direction on the wireless receiver 2 of FIG. 3. When the multiple wireless receivers 2 are installed, each wireless receiver 2 is preferably disposed to adjust the distance between the antennas. For example, when the antenna positions of the wireless receivers 2a and 2b of FIG. 1 are disposed to be adjusted in the transverse direction in the figure, the distance between the antennas can be thus adjusted. Similarly, when the antenna position of the wireless receiver 2c of FIG. 1 is disposed to be adjusted in the longitudinal direction in the figure, the distance to the antennas of the wireless receivers 2a and 2b can be thus adjusted. In such a way, the antenna position of each of the multiple wireless receivers 2 can be easily adjusted to reduce the influence of fading.

### <Method of Determining Position of Antenna 21>

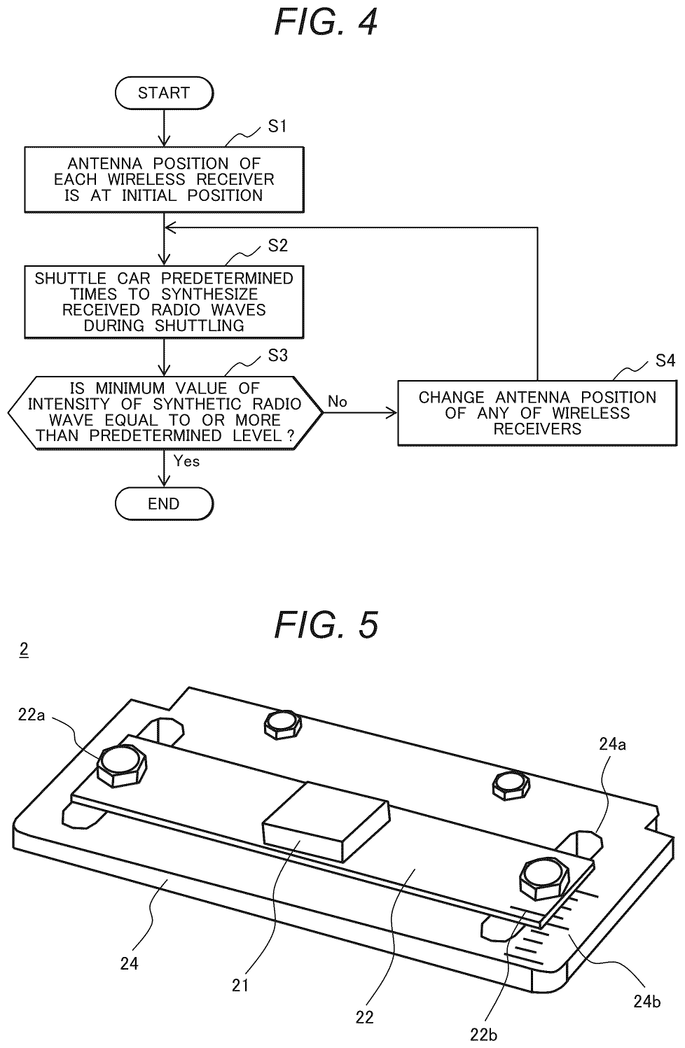

Here, a procedure of determining the antenna position of each wireless receiver 2 is explained using the flow chart of FIG. 4. The procedure is made at the time of installation of the elevator device 100.

First, at Step S1, the multiple wireless receivers 2 are installed to the upper portion of the elevator car 1, for example, as shown in FIG. 1. At this time, the position of the antenna 21 of each wireless receiver 2 is at an initial position (for example, the position where the bolt 22a is secured to the hole 23a on the front side).

Next, at Step S2, while a radio wave is transmitted from the wireless transmitter 3, the elevator car 1 is shuttled predetermined times (for example, ten times), during which a synthetic radio wave is generated from the received radio waves of the respective wireless receivers 2.

At Step S3, it is determined whether the minimum in the radio wave intensities of the synthetic radio waves generated at Step S2 is a predetermined level or more. Then, when the determination is Yes, it is determined that the synthetic radio wave having a predetermined level or more is always generable and the processing ends. The position of the antenna 21 of each wireless receiver 2 is thereby determined. In contrast, when the determination is No, the processing moves to Step S4.

At Step S4, the position of any antenna 21 (for example, the antenna 21 of the wireless receiver 2a on the support mechanism 12) is changed into a different position. After that, the processing returns to Step S2 and generates a synthetic radio wave again.

The combination of the antenna positions of the wireless receivers 2 can be determined to always generate a synthetic radio wave having a predetermined level or more by repeating the above Steps S2 to S4 until the minimum in the radio wave intensities of the synthetic radio waves becomes a predetermined level or more.

### <Advantageous Effect of Embodiment 1>

According to the elevator device of the present Embodiment explained above, when the multiple antennas are installed to the elevator car to generate a synthetic radio wave, each antenna can be disposed to suppress the influence of fading while a work space for maintenance personnel is ensured.

### Embodiment 2

Next, the elevator device 100 of Embodiment 2 is explained using FIG. 5. It is noted that the common points to ones of Embodiment 1 are not explained repeatedly.

In the wireless receiver 2 of Embodiment 1, the multiple holes 23a are provided to each transverse end portion of the base 23. In the wireless receiver 2 of the present Embodiment, a slot 24a having a length of λ/2 or more in the longitudinal direction and a fixed width is provided to each transverse end portion of the base 24. Therefore, any of the multiple holes 23a needs to be selected as the antenna position in Embodiment 1. The antenna position can be fixed to any position in the range of the slot 24a in the present Embodiment. Therefore, an environment in which it is difficult to generate a synthetic radio wave having a sufficient intensity even when any hole 23a of the base 23 of Embodiment 1 is selected is considerable. Even in such an environment, the antenna position where a synthetic radio wave having a sufficient intensity can be generated is identifiable by use of the base 24 of the present Embodiment.

It is noted that, since the adjustable range of the antenna position is stepless when the base 24 of FIG. 5 is used, it is useful to have a mark for identifying the current antenna position. Then, a linear mark 22b is attached to the front right end portion of the bracket 22 of the present Embodiment, and large and small scales 24b are attached to the base 24. Thereby, for example, the intensity of a synthetic radio wave at each of the positions where the mark 22b of the bracket 22 and the large scale 24b of the base 24 become linear is first evaluated. When those positions are not appropriate antenna positions, the intensity of a synthetic radio wave at each of the positions where the mark 22b of the bracket 22 and the small scale 24b of the base 24 become linear is evaluated. This enables improvement of work efficiency for identification of an appropriate antenna position.

### REFERENCE SIGNS LIST

100: elevator device,
101: hoistway,
102: guide rail,
1: elevator car,
11: guide roller,
12: support mechanism,
13: control device,
2: wireless receiver,
21: antenna,
22: bracket,
22a: bolt,
22b: mark,
23: base,
23a: hole,
24: base,
24a: slot,
24b: scale,
3: wireless transmitter

1. An elevator device that mediates wireless communications for communications between a control board of a hoistway and a control device of an elevator car,
the device comprising:
a guide rail installed to the hoistway;
the elevator car that moves up and down with being guided by the guide rail;
a wireless transmitter provided to a top portion of the hoistway,
a plurality of wireless receivers provided to an upper portion of the elevator car;
a guide roller that grips the guide rail; and
a support mechanism that rotatably supports the guide roller,
wherein at least any one of the plurality of wireless receivers is installed to an upper portion of the support mechanism provided to an upper surface of the elevator car.

2. The elevator device according to claim 1,
wherein at least any one of the plurality of wireless receivers is installed to an upper portion of the control device provided to the upper surface of the elevator car.

3. The elevator device according to claim 1,
wherein the wireless receiver includes:
an antenna that receives transmitted radio waves of the wireless transmitter;
a bracket that mounts the antenna and has a bolt; and
a base to which a plurality of holes that are linearly arranged,
wherein the bolt is secured to any one of the plurality of holes of the base to fix a position of the antenna.

4. The elevator device according to claim 3,
wherein a distance between a most front hole and a most back hole in the plurality of holes provided to the base is ½ wavelength or more of the transmitted radio wave.

5. The elevator device according to claim 3,
wherein the wireless receiver is installed to make a direction of the plurality of linearly arranged holes vertical relative to a nearest side surface of the elevator car.

6. The elevator device according to claim 1,
wherein the wireless receiver includes:
an antenna that receives a transmitted radio wave of the wireless transmitter;
a bracket that mounts the antenna and has a bolt; and
a base to which a slot that is long in a longitudinal direction is provided,
wherein the bolt is secured to any position of the slot of the base to fix a position of the antenna.

7. The elevator device according to claim 6,
wherein the slot provided to the base has ½ wavelength or more of the transmitted radio wave.

8. The elevator device according to claim 6,
wherein the wireless receiver is installed to make a longitudinal direction of the slot vertical to a nearest side surface of the elevator car.

9. The elevator device according to claim 6,
wherein a positioning mark is attached to the bracket and a positioning scale is attached to the base.
